(19) United States
(12) Patent Application Publication
(10) Pub. No.: US 2025/0296244 A1
(43) Pub. Date: Sep. 25, 2025

(54) ROBOT, LIGHT-EMITTING DEVICE, AND TEACHING METHOD

(71) Applicant: KABUSHIKI KAISHA TOSHIBA, Tokyo (JP)

(72) Inventors: Yasunori CHIBA, Yokohama (JP); Masahiro SAITO, Yokohama (JP); Tomoo SUZUKI, Suginami (JP); Kenichiro KANNO (Deceased); Toshinori UCHIDA, Fuchu (JP)

(73) Assignee: KABUSHIKI KAISHA TOSHIBA, Tokyo (JP)

(21) Appl. No.: 19/070,910

(22) Filed: Mar. 5, 2025

(30) Foreign Application Priority Data
Mar. 22, 2024 (JP) 2024-046136

(51) Int. Cl. B25J 15/00; B25J 19/00

(52) U.S. Cl. CPC B25J 15/0019; B25J 19/0037

(57) ABSTRACT

According to one embodiment, a robot includes a manipulator, a first end effector and first and second light-emitting parts. The first end effector is mounted to a distal part of the manipulator. The first light-emitting part is mounted to the distal part, the first light-emitting part irradiating a first line laser in a first direction. The second light-emitting part is mounted to the distal part, the second light-emitting part irradiating a second line laser in a second direction. The first direction is tilted with respect to an orientation of the first end effector in a first plane, the first plane being parallel to a direction from the distal part toward the first end effector. The second direction is tilted with respect to the orientation of the first end effector in a second plane, the second plane being parallel to the first direction and crossing the first plane.

### CROSS-REFERENCE TO RELATED APPLICATIONS

This application is based upon and claims the benefit of priority from Japanese Patent Application No. 2024-046136, filed on Mar. 22, 2024; the entire contents of which are incorporated herein by reference.

### FIELD

Embodiments of the invention generally relate to a robot, a light-emitting device, and a teaching method.

### BACKGROUND

There is a robot that can operate autonomously. Technology is desirable for such a robot so that an appropriate posture can be easily set.

### BRIEF DESCRIPTION OF THE DRAWINGS

FIG. 1 is a schematic view showing a robot system according to an embodiment;

FIG. 2 is a perspective view showing an end effector;

FIG. 3 is a side view showing the end effector;

FIG. 4 is a side view showing the end effector;

FIG. 5 is a schematic view showing line lasers;

FIGS. 6A and 6B are schematic views showing the line lasers;

FIGS. 7A and 7B are schematic views showing the line lasers;

FIGS. 8A and 8B are schematic views showing the line lasers;

FIG. 9 is a flowchart showing a teaching method according to the embodiment;

FIG. 10 is a flowchart showing a specific example of the teaching method according to the embodiment;

FIG. 11 is a schematic view showing the structure of a detector and a joined body;

FIGS. 12A to 12C are schematic views for describing operations of the detector;

FIG. 13 is a flowchart showing a teaching method of the posture of the detector;

FIG. 14 is a schematic view illustrating intensity data obtained by a probe;

FIGS. 15A to 15C are examples of images of the reflected wave intensity distribution obtained by processing the intensity data;

FIG. 16 is a schematic view illustrating a determined weld portion;

FIGS. 17A to 17C are other examples of images of the reflected wave intensity distribution obtained by processing the intensity data;

FIG. 18 is a flowchart showing an operation of the robot system according to the embodiment;

FIG. 19 is a flowchart showing an inspection by the robot system according to the embodiment;

FIG. 20 is a flowchart showing an operation of the robot system according to the embodiment; and

FIG. 21 is a schematic view illustrating a hardware configuration.

### DETAILED DESCRIPTION

According to one embodiment, a robot, includes a manipulator, a first end effector, a first light-emitting part, and a second light-emitting part. The first end effector is mounted to a distal part of the manipulator. The first light-emitting part is mounted to the distal part, the first light-emitting part irradiating a first line laser in a first direction. The second light-emitting part is mounted to the distal part, the second light-emitting part irradiating a second line laser in a second direction. The first direction is tilted with respect to an orientation of the first end effector in a first plane, the first plane being parallel to a direction from the distal part toward the first end effector. The second direction is tilted with respect to the orientation of the first end effector in a second plane, the second plane being parallel to the first direction and crossing the first plane.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

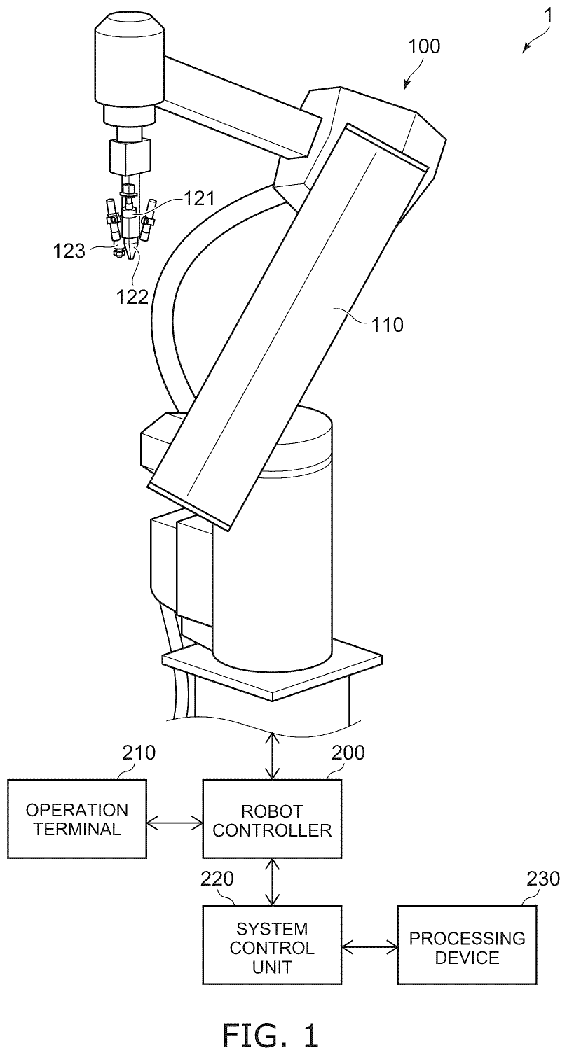

FIG. 1 is a schematic view showing a robot system according to an embodiment.

As shown in FIG. 1, the robot system 1 according to the embodiment includes a robot 100, a robot controller 200, an operation terminal 210, a system control unit 220, and a processing device 230.

The robot controller 200 controls motions of the robot 100. The robot controller 200 includes a control circuit, a servo controller, a power supply device, etc. The robot controller 200 moves the robot 100 according to a prestored motion program.

The operation terminal 210 is a terminal device for operating the robot 100. The operation terminal 210 is a so-called teaching pendant. The operation terminal 210 is connected with the robot controller 200 and accepts input of a motion program from a user, input of settings related to the robot 100, etc. The user uses the operation terminal 210 to modify, correct, or newly generate teaching data, etc. Teaching data is data for teaching the motion of the robot 100 to the robot 100.

The system control unit 220 performs calculations necessary for the operation of the robot 100. The system control unit 220 displays a user interface for receiving information input by the user and for outputting information to the user. The robot controller 200 is connected with the operation terminal 210 and the system control unit 220 via wireless communication, wired communication, or a network.

The processing device 230 processes data obtained by the end effector of the robot 100. The processing device 230 is connected with the system control unit 220 via wireless communication, wired communication, or a network.

The robot 100 includes a manipulator 110, an imaging device 121, a detector 122, a dispenser 123, a first light-emitting part 131, and a second light-emitting part 132. For example, the manipulator 110 is vertical articulated. The manipulator 110 may be horizontal articulated or parallel link. The manipulator 110 may include a combination of at least two selected from vertical articulated, horizontal articulated, and parallel link. It is favorable for the manipulator 110 to have not less than six degrees of freedom.

The imaging device 121, the detector 122, and the dispenser 123 are mounted to the distal part of the manipulator 110 as end effectors. For example, the system control unit 220 controls the imaging device 121 and the dispenser 123. Another controller for controlling the dispenser 123 may be provided. The processing device 230 controls the detector 122.

The imaging device 121 images the object of the task of the robot 100. To improve the work performance of the robot 100, it is favorable for the imaging device 121 to be small. To downsize the imaging device 121, it is favorable for the imaging device 121 to be a fixed focal length camera. The imaging device 121 is an example of a first end effector.

The detector 122 probes (performs probing) of the object. In the probing, an ultrasonic wave is transmitted toward the object; and a reflected wave is detected (received). The detector 122 transmits the detection result of the reflected wave to the processing device 230. The detector 122 is an example of a second end effector.

The dispenser 123 dispenses a couplant toward the surface of the object. The couplant is a gel object and is used to improve the acoustic compatibility between the object and the detector 122. The dispenser 123 is another example of the second end effector.

The first light-emitting part 131 and the second light-emitting part 132 are mounted to the distal part of the manipulator 110. The first light-emitting part 131 and the second light-emitting part 132 irradiate line lasers on the surface of the object.

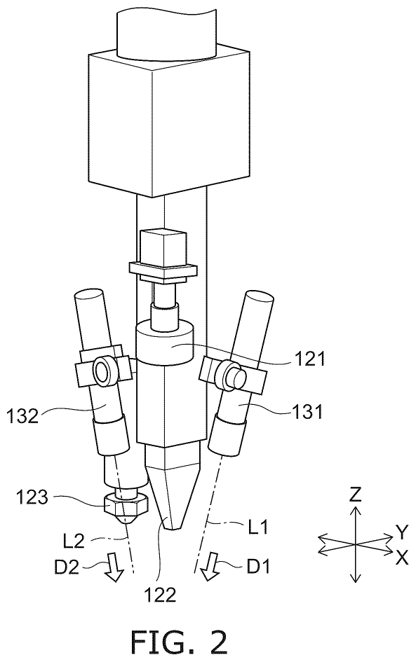

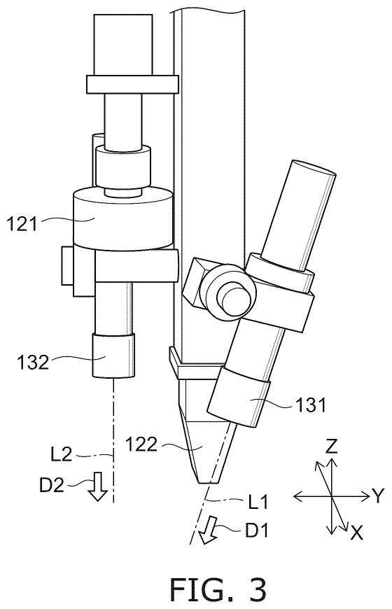

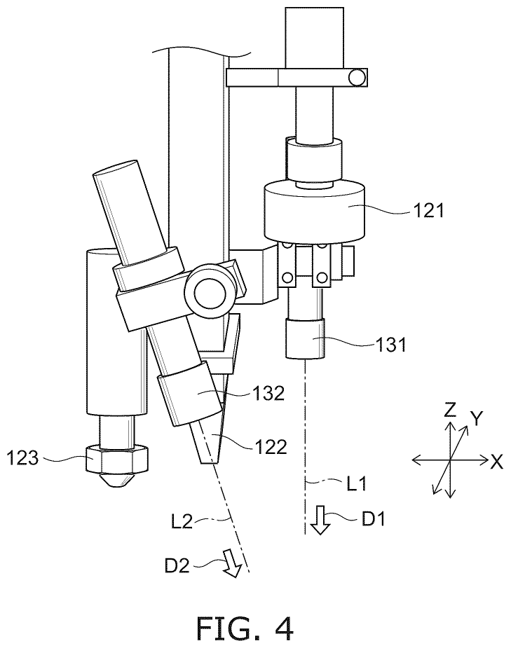

FIG. 2 is a perspective view showing an end effector. FIGS. 3 and 4 are side views showing the end effector.

Herein, a system orthogonal coordinate system is used in the description of the embodiments as shown in FIGS. 2 to 4. The direction from the distal part of the manipulator 110 toward the imaging device 121 is taken as a Z-direction (a first direction). Two mutually-orthogonal directions perpendicular to the Z-direction are taken as an X-direction (a second direction) and a Y-direction (a third direction).

The imaging device 121, the detector 122, and the dispenser 123 face substantially the Z-direction. In other words, the lens and image sensor of the imaging device 121 face the Z-direction; and the imaging device 121 images the object positioned in the Z-direction with respect to the imaging device 121. The detector 122 transmits an ultrasonic wave toward the Z-direction. The dispenser 123 dispenses a couplant in the Z-direction. However, the imaging device 121, the detector 122, and the dispenser 123 may be tilted with respect to the Z-direction within ranges that have no substantial effect on the functions of the imaging device 121, the detector 122, and the dispenser 123.

As shown in FIGS. 2 and 3, the first light-emitting part 131 irradiates a first line laser L1 in a first direction D1. The first direction D1 is tilted with respect to the Z-direction in a first plane parallel to the Z-direction.

As shown in FIGS. 2 and 4, the second light-emitting part 132 irradiates a second line laser L2 in a second direction D2. The second direction D2 is tilted with respect to the Z-direction in a second plane that is parallel to the Z-direction and crosses the first plane. The second direction D2 is not parallel to the first direction D1.

In the example shown in FIGS. 2 to 4, the first plane is parallel to the Y-Z plane; and the second plane is parallel to the X-Z plane. The first plane and the second plane are orthogonal to each other.

When the robot 100 moves the end effector, the manipulator 110 is moved so that the control point has a pre-taught posture. The control point is a point at which the posture is controlled, and is positioned, for example, at any one point on the end effector. The posture is represented by the position and the angle. The position includes the coordinates of three mutually-orthogonal axes. The angle includes tilts around the three mutually-orthogonal axes.

The posture that is taught affects the accuracy of the operation of the end effector. For example, a clear image is not obtained when the posture of the imaging device 121 when imaging is inappropriate. An accurate reflected wave detection result is not obtained when the posture of the detector 122 when probing is inappropriate. The couplant cannot be adhered at the appropriate position of the object when the posture of the dispenser 123 when dispensing the couplant is inappropriate. Accordingly, it is desirable to appropriately teach the posture.

The first light-emitting part 131 and the second light-emitting part 132 are used to appropriately set the posture of the end effector. The first light-emitting part 131 and the second light-emitting part 132 are mounted so that the first line laser L1 and the second line laser L2 have a prescribed positional relationship when the positional relationship between the end effector and the object is in a prescribed state.

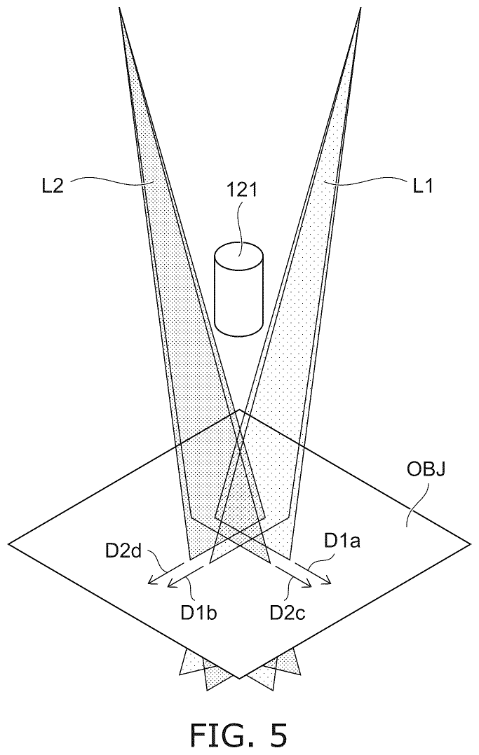

FIGS. 5, 6A, 6B, 7A, 7B, 8A, and 8B are schematic views showing line lasers.

A specific example will now be described in which the posture of the imaging device 121 when operating is taught using the first light-emitting part 131 and the second light-emitting part 132. The first light-emitting part 131 and the second light-emitting part 132 respectively irradiate the first line laser L1 and the second line laser L2 on the object. In the illustrated example, the first line laser L1 and the second line laser L2 each are cross-line lasers. Each cross-line laser includes two mutually-orthogonal lasers. Two straight lines that cross each other appear at the surface of an object on which a cross-line laser is irradiated.

As shown in FIG. 5, the first line laser L1 spreads along a first extension direction D1a and a second extension direction D1b at the surface of an object OBJ. The first extension direction Da and the second extension direction D1b cross each other. The second line laser L2 spreads along a third extension direction D2c and a fourth extension direction D2d at the surface of the object OBJ. The third extension direction D2c and the fourth extension direction D2d cross each other.

The first light-emitting part 131 and the second light-emitting part 132 are mounted so that the first line laser L1 and the second line laser L2 overlap at the surface of the object OBJ when the focal point of the imaging device 121 is positioned on the surface of the object and the imaging device 121 squarely faces the surface.

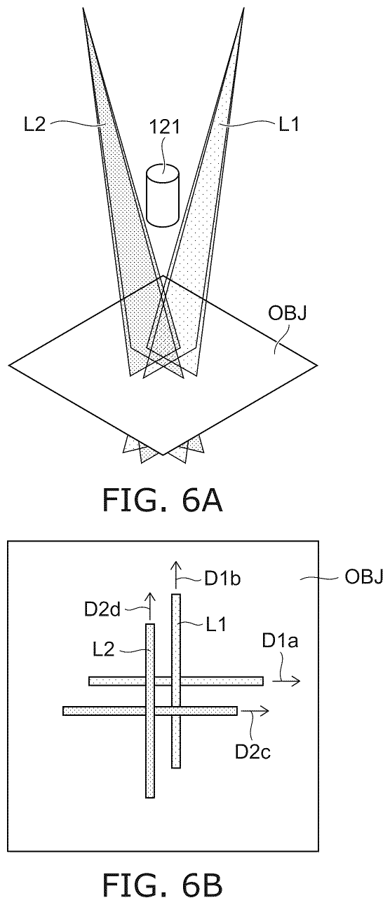

FIGS. 6A and 6B show a state in which the imaging device 121 squarely faces the surface of the object OBJ, but the distance between the imaging device 121 and the surface is shifted from the focal length of the imaging device 121. In such a case, at the surface of the object OBJ, the first extension direction Dla and the third extension direction D2c are parallel to each other; and the second extension direction D1b and the fourth extension direction D2d are parallel to each other. On the other hand, the first line laser L1 and the second line laser L2 are shifted from each other in a direction perpendicular to the orientation of the imaging device 121.

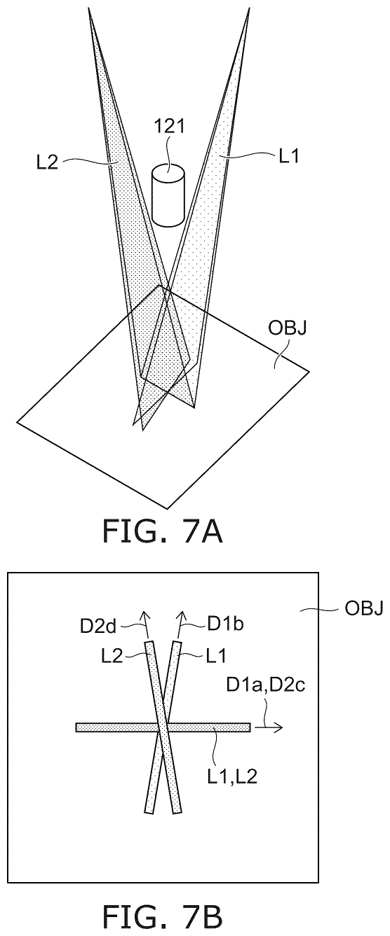

FIGS. 7A and 7B show a state in which the distance between the imaging device 121 and the surface of the object OBJ matches the focal length of the imaging device 121, but the imaging device 121 is tilted with respect to the surface. In such a case, at the surface of the object OBJ, one straight line of the first line laser L1 and one straight line of the second line laser L2 are parallel to each other and overlap. On the other hand, the other straight line of the first line laser L1 and the other straight line of the second line laser L2 are not parallel to each other, and do not overlap.

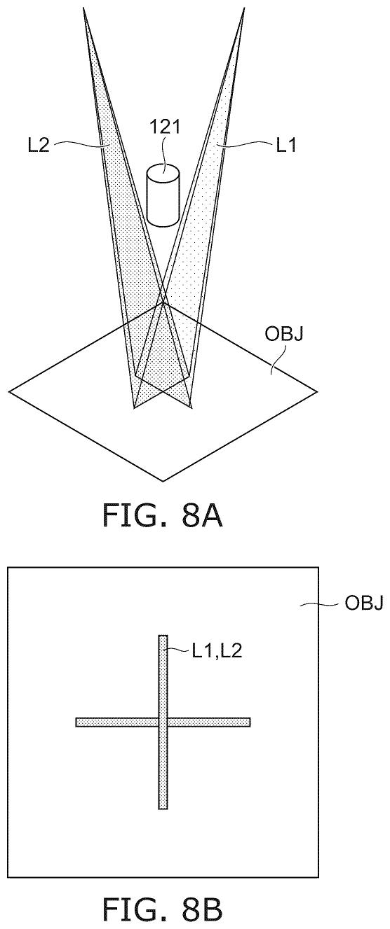

FIGS. 8A and 8B show a state in which the imaging device 121 and the surface of the object OBJ squarely face each other, and the distance between the imaging device 121 and the surface matches the focal length of the imaging device 121. In such a case, at the surface of the object OBJ, the multiple straight lines of the first line laser L1 respectively overlap the multiple straight lines of the second line laser L2.

The first line laser L1 and the second line laser L2 overlapping at the surface of the object OBJ indicates that the end effector has the appropriate posture. The posture of the control point at this time is taught. As a result, when the robot 100 automatically operates, the imaging device 121 can be set to the appropriate posture; and the imaging device 121 can acquire an appropriate image of the surface of the object OBJ.

For example, a person adjusts the position and angle of the manipulator 110 while confirming the first line laser L1 and the second line laser L2 irradiated on the surface of the object OBJ. When the first line laser L1 and the second line laser L2 overlap, the person stops the manipulator 110 and teaches the posture of the control point. In the illustrated example, the first line laser L1 and the second line laser L2 overlapping indicates a state in which the center of the first line laser L1 and the center of the second line laser L2 match and the line segments of the first line laser L1 and the line segments of the second line laser L2 are parallel to each other.

The imaging device 121 may image the first line laser L1 and the second line laser L2 irradiated on the surface. Based on the obtained image, the system control unit 220 calculates the movement amount of the manipulator 110 necessary for the first and second line lasers L1 and L2 to overlap. The robot controller 200 calculates the drive amounts of the motors of the manipulator 110 necessary for the movement amount. The robot controller 200 drives the motors by the calculated drive amounts. As a result, the manipulator 110 is moved so that the first line laser L1 and the second line laser L2 overlap at the surface of the object OBJ.

An example is described herein in which the posture of the imaging device 121 when operating is taught using the first light-emitting part 131 and the second light-emitting part 132. The teaching is not limited to the example; the first light-emitting part 131 and the second light-emitting part 132 may be used to teach the posture of the detector 122 or the dispenser 123 when operating.

For example, when teaching the posture of the dispenser 123 when operating, the first light-emitting part 131 and the second light-emitting part 132 are mounted at the periphery of the dispenser 123. The first light-emitting part 131 and the second light-emitting part 132 are mounted so that the first line laser L1 and the second line laser L2 overlap each other when the dispenser 123 and the object OBJ have a desirable positional relationship. The person can teach the robot controller 200 the appropriate posture of the dispenser 123 when operating while confirming the first line laser L1 and the second line laser L2 irradiated on the surface of the object OBJ. By setting the dispenser 123 to the appropriate posture, the couplant can be more appropriately adhered to the surface of the object OBJ.

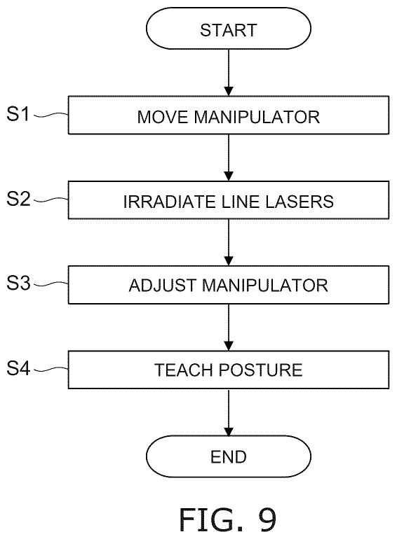

FIG. 9 is a flowchart showing a teaching method according to the embodiment.

The robot controller 200 moves the manipulator 110 so that the end effector faces the surface of the object OBJ (step S1). The first light-emitting part 131 and the second light-emitting part 132 irradiate the first line laser L1 and the second line laser L2 toward the surface of the object OBJ (step S2). The manipulator 110 is adjusted so that the first line laser L1 and the second line laser L2 overlap at the surface (step S3). When the first line laser L1 and the second line laser L2 overlap, the operation terminal 210 is used to teach the posture of the control point at that time to the robot 100 (step S4). Thus, the teaching of the posture ends.

Advantages of the embodiment will now be described.

As described above, it is desirable to appropriately set the postures of the end effectors to appropriately operate the end effectors. To appropriately set the postures of the end effectors, it is effective to pre-teach the postures of the end effectors. On the other hand, the postures for appropriately operating the end effectors are different for each end effector function. Moreover, it is not easy to correctly set the postures so that the end effectors can operate appropriately. In particular, the imaging device 121, the dispenser 123, etc., are separated from the object when operating. Knowledge and experience related to these end effectors are necessary to correctly teach the postures of the end effectors so that the end effectors can operate appropriately.

For this problem, the robot 100 according to the embodiment includes the first light-emitting part 131 and the second light-emitting part 132 that are mounted to the distal part of the manipulator 110. The first light-emitting part 131 and the second light-emitting part 132 respectively irradiate the first line laser L1 and the second line laser L2 toward the surface of the object. The first light-emitting part 131 and the second light-emitting part 132 are mounted so that, when the posture of the manipulator 110 is appropriate, the first line laser L1 and the second line laser L2 are positioned in a prescribed state when irradiated on the surface. Accordingly, the manipulator 110 can be set to the appropriate posture by positioning the irradiated first line laser L1 and the irradiated second line laser L2 in the prescribed state.

For the imaging device 121, for example, a person cannot easily ascertain whether or not the imaging device 121 and the surface of the object OBJ face each other squarely and accurately. A person also cannot visually check the focal length of the imaging device 121. However, according to the embodiment, a person can move the manipulator 110 while confirming the first line laser L1 and the second line laser L2 to easily realize a state in which the imaging device 121 and the surface of the object OBJ squarely face each other and the distance between the imaging device 121 and the surface matches the focal length of the imaging device 121.

For the dispenser 123 as well, a person cannot easily ascertain whether or not the dispenser 123 and the surface of the object OBJ squarely face each other. It is difficult for a person of limited experience to appropriately set the distance between the dispenser 123 and the object OBJ. A person can move the manipulator 110 while confirming the first line laser L1 and the second line laser L2 to easily realize a state in which the dispenser 123 and the surface of the object OBJ squarely face each other and the distance between the dispenser 123 and the surface is appropriately set.

It is favorable for the color of the first line laser L1 and the color of the second line laser L2 to be different from each other. By setting the color of the first line laser L1 and the color of the second line laser L2 to be different from each other, a person can easily discriminate the first line laser L1 and the second line laser L2 irradiated on the object OBJ. Therefore, a person can easily determine whether or not the first line laser L1 and the second line laser L2 overlap each other. As an example, the color of the first line laser L1 is one selected from the three primary colors (red, green, and blue); and the color of the second line laser L2 is another one selected from the three primary colors (red, green, and blue).

After teaching is performed by the method described above, the robot 100 automatically moves based on the taught information. When the end effector operates, the robot controller 200 moves the manipulator 110 so that the control point has the taught posture.

As a specific example, the posture of the control point of the imaging device 121 when operating, the posture of the control point of the detector 122 when operating, and the posture of the control point of the dispenser 123 when operating are preregistered. When the imaging device 121 operates, the robot controller 200 moves the manipulator 110 so that the posture of the control point is the pre-taught posture of the imaging device 121 when operating. As a result, the imaging device 121 is set to the appropriate posture. Similarly, when the detector 122 operates, the robot controller 200 moves the manipulator 110 so that the posture of the control point is the pre-taught posture of the detector 122 when operating. When the dispenser 123 operates, the robot controller 200 moves the manipulator 110 so that the posture of the control point is the pre-taught posture of the dispenser 123 when operating.

To simplify the following description, the posture of the control point of the imaging device 121 when operating also is called “the posture of the imaging device 121”. The posture of the control point of the detector 122 when operating also is called “the posture of the detector 122”. The posture of the control point of the dispenser 123 when operating also is called “the posture of the dispenser 123”.

When the robot 100 includes multiple end effectors as shown in FIGS. 1 and 2, the posture is taught for each end effector. In such a case, the first light-emitting part 131 and the second light-emitting part 132 are used to teach the posture of at least one of the end effectors when operating. Subsequently, the postures of the other end effectors may be adjusted according to preregistered positional relationships between the end effectors.

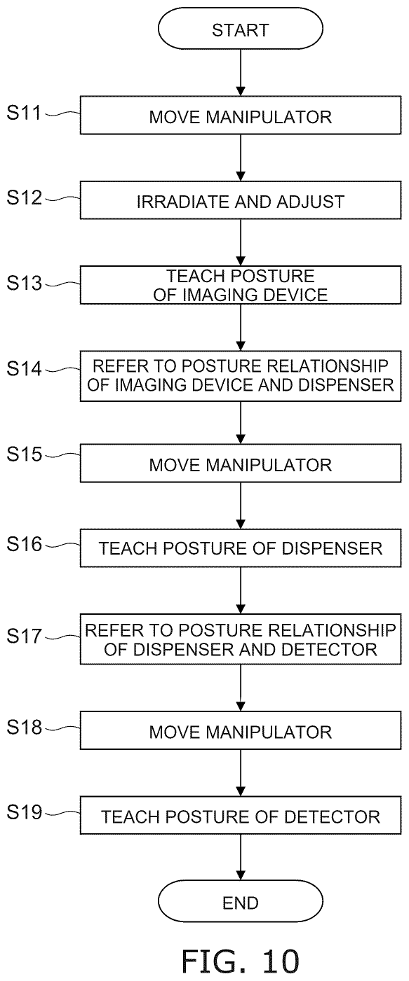

FIG. 10 is a flowchart showing a specific example of the teaching method according to the embodiment.

First, the robot controller 200 moves the manipulator 110 so that the imaging device 121 faces the surface of the object OBJ (step S11). Subsequently, processing similar to steps S2 to S4 is performed. Specifically, the line lasers are irradiated on the surface of the object OBJ, and the manipulator 110 is adjusted (step S12). Also, the posture of the imaging device 121 is taught (step S13).

The system control unit 220 refers to a preregistered relationship between the posture of the imaging device 121 and the posture of the dispenser 123 (step S14). For example, the relationship between the desirable posture of the imaging device 121 and the desirable posture of the dispenser 123 is preregistered. The system control unit 220 calculates the difference between the preregistered position of the imaging device 121 and the preregistered position of the dispenser 123 as the translation amount of the manipulator 110. The system control unit 220 calculates the difference between the preregistered angle of the imaging device 121 and the preregistered angle of the dispenser 123 as the rotation amount of the manipulator 110.

The robot controller 200 moves the manipulator 110 by the calculated movement amount (step S15). If the manipulator 110 is appropriately adjusted in step S12, the posture of the imaging device 121 is in a favorable state. By moving the manipulator 110 from this state based on the preregistered posture relationship of the imaging device 121 and the dispenser 123, the dispenser 123 can be set to a desirable posture. The posture of the dispenser 123 may be finely adjusted as necessary. Subsequently, the posture of the dispenser 123 when operating is taught (step S16).

After teaching the posture of the dispenser 123, the posture of the detector 122 is taught. Similarly, the system control unit 220 refers to the preregistered relationship between the posture of the imaging device 121 and the posture of the dispenser 123 (step S17). Based on the preregistered relationship, the system control unit 220 calculates the movement amount of the manipulator 110 necessary for the desirable posture of the detector 122. The robot controller 200 moves the manipulator 110 by the calculated movement amount (step S18). The posture of the detector 122 may be finely adjusted as necessary. Subsequently, the posture of the detector 122 when operating is taught (step S19).

According to the method shown in FIG. 10, the posture that is taught for the imaging device 121 also is utilized to teach the posture of the detector 122 and teach the posture of the dispenser 123. As a result, the posture of the detector 122 and the posture of the dispenser 123 can be easily taught.

The robot system 1 described above can be used to inspect a joined body.

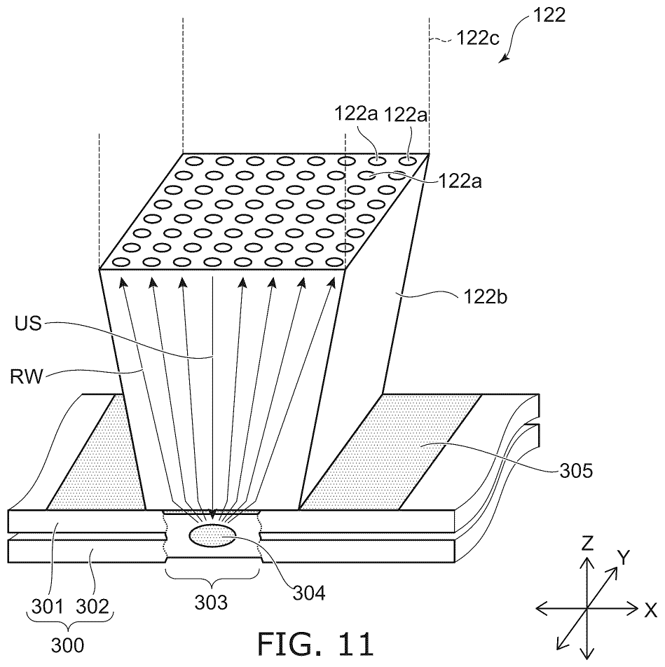

FIG. 11 is a schematic view showing the structure of a detector and a joined body.

As shown in FIG. 11, the joined body 300 includes a metal plate 301 (a first member) and a metal plate 302 (a second member). The metal plate 301 and the metal plate 302 are joined at a weld portion 303. In other words, a boundary between the metal plate 301 and the metal plate 302 is not present at the weld portion 303. A solidified portion 304 that is formed by mixing the molten metal is present at the weld portion 303. The weld portion 303 is formed by resistance spot welding.

The detector 122 probes the weld portion 303 of the joined body 300. As shown in FIG. 11, the detector 122 includes detection elements 122a, a propagating part 122b, and a housing 122c.

The detection elements 122a are two-dimensionally arranged along the X-direction and Y-direction. For example, the detection element 122a is a transducer that emits an ultrasonic wave of a frequency of not less than 1 MHz and not more than 100 MHZ. Each detection element 122a transmits the ultrasonic wave along the Z-direction.

The multiple detection elements 122a are located at the distal end of the housing 122c and are covered with the propagating part 122b. The propagating part 122b is positioned between the joined body 300 and the detection elements 122a when the detector 122 is caused to contact the joined body 300. When the detection element 122a emits an ultrasonic wave, the ultrasonic wave propagates through the propagating part 122b and is transmitted outside the detector 122. When the ultrasonic wave is reflected, the reflected wave propagates through the propagating part 122b and reaches the detection elements 122a.

The detection elements 122a detect the reflected wave. The intensity of the signal detected by the detection elements 122a corresponds to the intensity of the reflected wave. The detector 122 acquires a detection result indicating the reflected wave intensity and transmits the detection result to the processing device 230.

The propagating part 122b includes a resin material or the like through which the ultrasonic wave easily propagates. Deformation, damage, and the like of the detection elements 122a can be suppressed by the propagating part 122b when the detector 122 contacts the weld portion 303. The propagating part 122b has a hardness sufficient to suppress the deformation, damage, and the like when contacting the weld portion 303.

A couplant 305 is adhered to the surface of the joined body 300 so that the ultrasonic wave propagates easily between the detector 122 and the joined body 300 when probing. Each detection element 122a transmits an ultrasonic wave US toward the joined body 300 to which the couplant 305 is adhered.

Or, the propagating part 122b may be easily deformable along the surface shape of the object. The use of the couplant may be omitted if the propagating part 122b is closely adhered to the joined body 300 and sufficient acoustic matching between the propagating part 122b and the joined body 300 is obtained by the deformation of the propagating part 122b.

For example, as shown in FIG. 11, one detection element 122a transmits the ultrasonic wave US toward the joined body 300. A portion of the ultrasonic wave US is reflected by the upper surface, lower surface, or the like of the joined body 300. The multiple detection elements 122a each detect a reflected wave RW. In the probe, each detection element 122a sequentially transmits the ultrasonic wave US; and each reflected wave RW is detected by the multiple detection elements 122a.

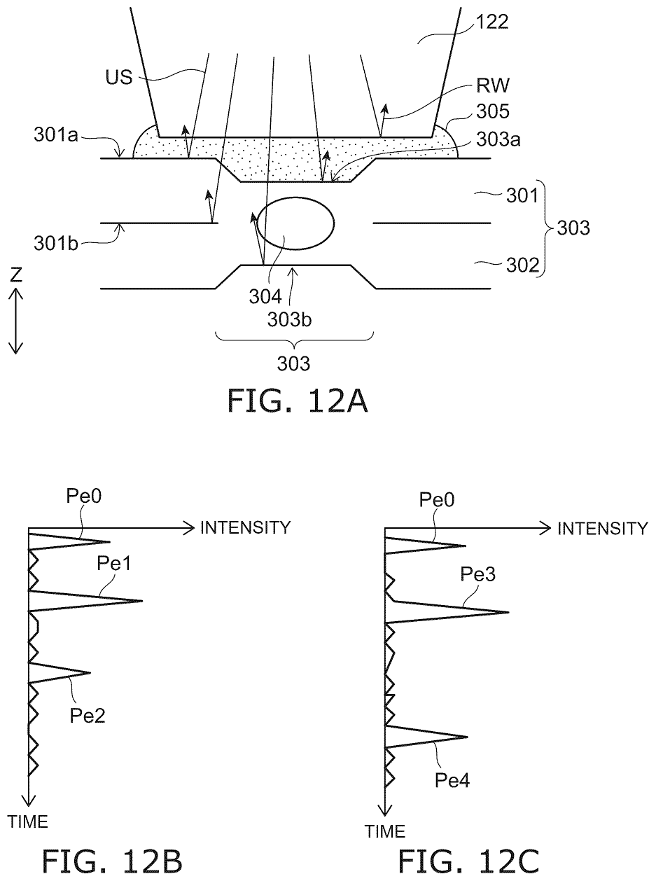

FIGS. 12A to 12C are schematic views for describing operations of the detector.

As illustrated in FIG. 12A, a portion of the ultrasonic wave US is reflected by an upper surface 301a of the metal plate 301 or an upper surface 303a of the weld portion 303. Another portion of the ultrasonic wave US is incident on the joined body 300 and reflected by a lower surface 301b of the metal plate 301 or a lower surface 303b of the weld portion 303.

The Z-direction positions of the upper surface 301a, the upper surface 303a, the lower surface 301b, and the lower surface 303b are different from each other. In other words, Z-direction distances between the detector 122 and these surfaces are different from each other. The detector 122 detects peaks of the reflected wave intensities when receiving the reflected waves from these surfaces. Which surface reflected the ultrasonic wave US can be determined by calculating the time until each peak is detected after transmitting the ultrasonic wave US.

The intensity of the reflected wave may be represented in any form. For example, the reflected wave intensity that is output from the detector 122 includes positive values and negative values according to the phase. Various processing may be performed based on the reflected wave intensity including the positive values and the negative values. The reflected wave intensity that includes the positive values and the negative values may be converted into absolute values. The average value of the reflected wave intensities may be subtracted from the reflected wave intensity at each time. Or, the weighted average value, the weighted moving average value, etc., of the reflected wave intensities may be subtracted from the reflected wave intensity at each time. The various processing described in the application can be performed even when the results of such processing applied to the reflected wave intensity are used.

FIGS. 12B and 12C are graphs illustrating the relationship between the time after transmitting the ultrasonic wave US and the intensity of the reflected wave RW. Here, the intensity of the reflected wave RW is illustrated as an absolute value. The graph of FIG. 12B illustrates the reception result of the reflected waves RW from the upper surface 301a and the lower surface 301b of the metal plate 301. The graph of FIG. 12C illustrates the reception result of the reflected waves RW from the upper surface 303a and the lower surface 303b of the weld portion 303.

In the graphs of FIGS. 12B and 12C, a peak Pe0 occurring first is based on the reflected wave RW from the tip of the detector 122. In FIG. 12B, a peak Pe1 occurring second is based on the reflected wave RW from the upper surface 301a. A peak Pe2 occurring third is based on the reflected wave RW from the lower surface 301b. The times at which the peaks Pe1 and Pe2 are detected correspond respectively to the Z-direction position of the upper surface 301a and the Z-direction position of the lower surface 301b. The difference between the time at which the peak Pe1 is detected and the time at which the peak Pe2 is detected corresponds to the Z-direction distance between the upper surface 301a and the lower surface 301b.

Similarly, in the graph of FIG. 12C, a peak Pe3 occurring second is based on the reflected wave RW from the upper surface 303a. A peak Pe4 occurring third is based on the reflected wave RW from the lower surface 303b. The times at which the peaks Pe3 and Pe4 are detected correspond respectively to the Z-direction position of the upper surface 303a and the Z-direction position of the lower surface 303b. The difference between the time at which the peak Pe3 is detected and the time at which the peak Pe4 is detected corresponds to the Z-direction distance between the upper surface 303a and the lower surface 303b.

The processing device 230 processes the detection result of the system control unit of the reflected wave and acquires data related to the weld portion 303. For example, the processing device 230 determines the position of the weld portion 303 of the joined body 300. The processing device 230 may calculate the tilt of the upper surface 303a. The processing device 230 may calculate the diameter or thickness of the weld portion 303.

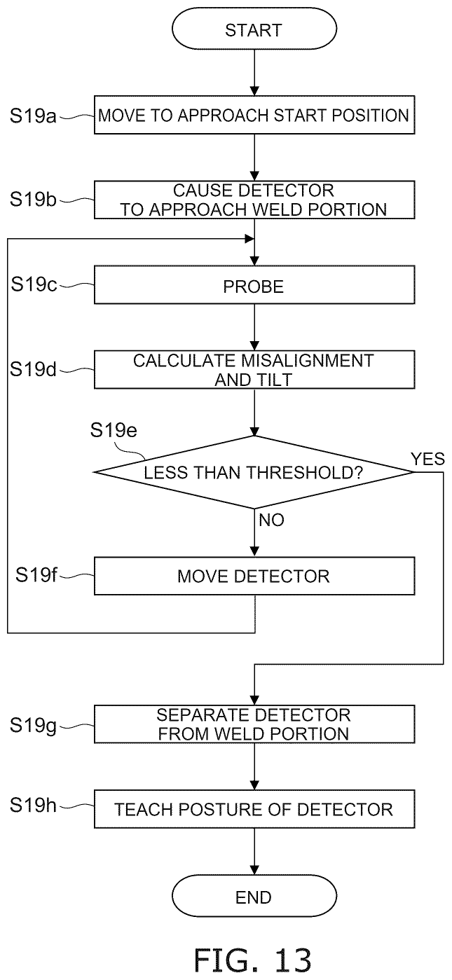

FIG. 13 is a flowchart showing a teaching method of the posture of the detector.

When teaching the posture of the detector 122, the result of the probe described above may be used. Specifically, the processing shown in FIG. 13 is performed in step S19 shown in FIG. 10. First, the detector 122 is moved to an approach start position by moving the manipulator 110 in step S18 (step S19a). To contact the weld portion 303, the detector 122 is moved a prescribed Z-direction distance toward the weld portion 303. The approach start position is the position at which the movement toward the weld portion 303 is started, and is separated from the weld portion 303 by a prescribed Z-direction distance.

The robot controller 200 causes the detector 122 to approach the weld portion 303 (step S19b). When the detector 122 contacts the weld portion 303, the robot controller 200 causes the detector 122 to perform a probe (step S19c). The processing device 230 acquires the detection result of the reflected wave. Based on the detection result of the reflected wave, the system control unit 220 calculates the misalignment of the detector 122 with respect to the weld portion 303 and the tilt between the weld portion 303 and the detector 122 (step S19d). Specifically, the system control unit 220 calculates the center position of the weld portion 303 in the X-Y plane based on the detection result of the reflected wave. The system control unit 220 calculates the misalignment of the center position of the detector 122 with respect to the center position of the weld portion 303. The system control unit 220 also calculates the average tilt of the weld portion 303 with respect to the detector 122 based on the detection result of the reflected wave.

The system control unit 220 determines whether or not the calculation misalignment is less than a preset threshold (distance), and determines whether or not the calculated tilt is less than a preset threshold (angle) (step S19e). When the misalignment is not less than the threshold or the tilt is not less than the threshold, the robot controller 200 moves the detector 122 to reduce the misalignment or the tilt (step S19f). Subsequently, step S19c is re-performed. Steps S19c to S19e are repeated until the misalignment and the tilt are sufficiently small.

When the misalignment is less than the threshold and the tilt is not less than the threshold, the robot controller 200 separates the detector 122 from the weld portion 303 by moving the detector 122 by the prescribed Z-direction distance (step S19g). As a result, the detector 122 is moved to the approach start position. After step S19g, the approach start position is taught as the posture of the detector 122 (step S19h).

A specific example of the calculation method of the center position of the weld portion 303 of the teaching method described above will now be described.

In the probing as described above, each detection element 122a sequentially transmits an ultrasonic wave; and the multiple detection elements 122a detect each reflected wave. In the specific example shown in FIG. 11, sixty-four detection elements 122a are arranged 8×8. In such a case, the sixty-four detection elements 122a sequentially transmit ultrasonic waves. One detection element 122a repeatedly detects a reflected wave 64 times. The detection result of the Z-direction reflected wave intensity distribution is output 64 times from the one detection element 122a. The sixty-four reflected wave intensity distributions output from the one detection element 122a are summed. The summed intensity distributions are the intensity distribution for one probing at the coordinate at which the one detection element 122a is located. Similar processing is performed for the detection results of each of the sixty-four detection elements 122a. Aperture synthesis of the detection results of the detection elements 122a may be performed to increase the resolution in the X-direction and Y-direction. By the processing described above, the Z-direction reflected wave intensity distribution at points in the X-Y plane is generated. In other words, three-dimensional intensity data that includes the reflected wave intensity at points in the X-direction, the Y-direction, and the Z-direction is obtained.

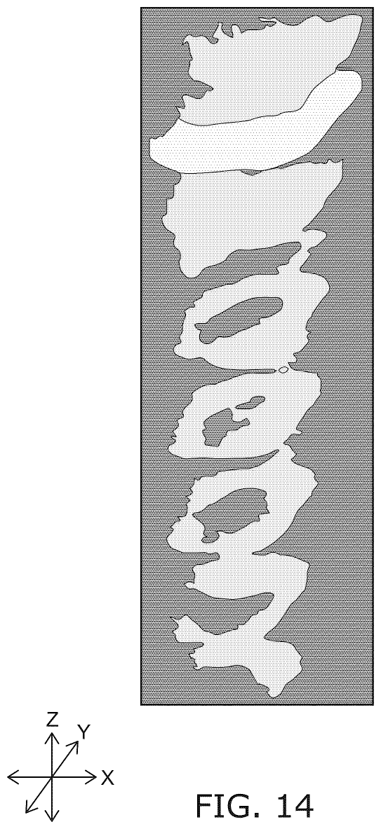

FIG. 14 is a schematic view illustrating intensity data obtained by the probe.

FIG. 14 schematically shows a three-dimensional intensity distribution. The schematic view of FIG. 14 shows the weld portion 303 vicinity of the three-dimensional intensity data. The intensity is illustrated by being binarized. In FIG. 14, portions at which the luminance is high are portions at which the reflected wave intensity of the ultrasonic wave is relatively large. In the example of FIG. 14, reflected waves from the upper surface 303a of the weld portion 303, reflected waves from the lower surface 303b, and reflected waves of multiple reflections between the upper surface 303a and the lower surface 303b are illustrated.

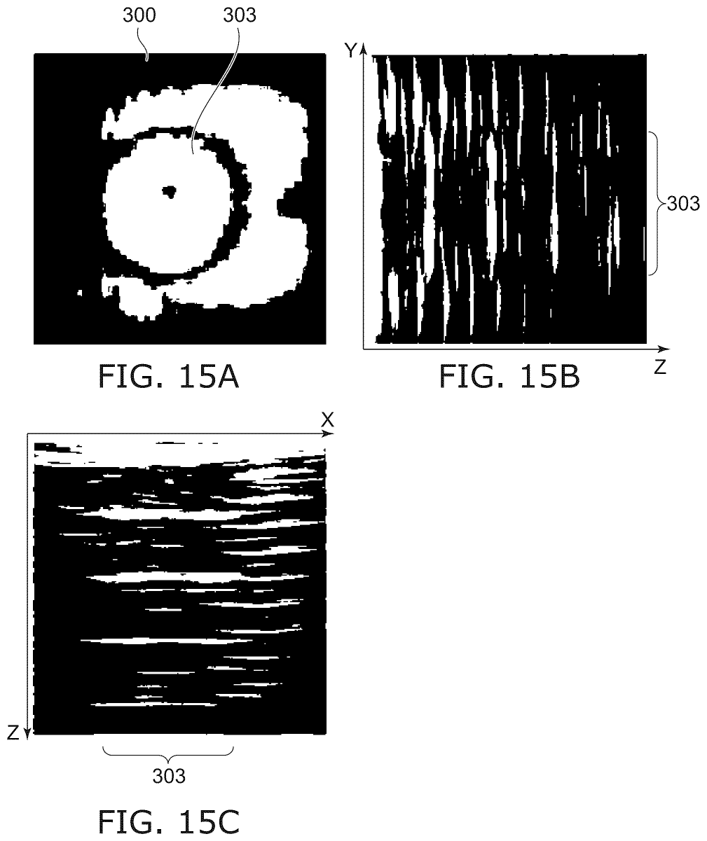

FIGS. 15A to 15C are examples of images of the reflected wave intensity distribution obtained by processing the intensity data.

The processing device 230 acquires the data shown in FIGS. 15A to 15C by processing the intensity data. FIG. 15A shows the reflected wave intensity distribution in the X-Y plane at the weld portion 303 vicinity. FIG. 15B shows the reflected wave intensity distribution in the Y-Z plane at the weld portion 303 vicinity. FIG. 15C shows the reflected wave intensity distribution in the X-Z plane at the weld portion 303 vicinity.

The data of FIG. 15A is obtained by summing the intensity in the Z-direction at points in the X-Y plane. The data of FIG. 15B is obtained by summing the intensity in the X-direction at points in the Z-direction. The data of FIG. 15C is obtained by summing the intensity in the Y-direction at points in the Z-direction. FIGS. 15A to 15C show the schematically binarized intensities of the reflected waves. The white points indicate that the intensity of the reflected wave is relatively high at those points. The black points indicate that the intensity of the reflected wave is relatively low at those points.

For example, the processing device 230 calculates the centroid position of the intensity as the center position of the weld portion 303 for the reflected wave intensity distribution in the X-Y plane shown in FIG. 15A. For example, as shown in FIG. 15A, the luminous centroid position of the binarized image may be calculated. Or, the luminous centroid position may be calculated for an image in which each pixel has a pixel value of one of three or more levels (e.g., 0 to 255).

Or, the processing device 230 may calculate the centroid position by extracting the reflected wave component from the weld portion 303 in the Z-direction. For example, as shown in FIGS. 15B and 15C, the period at which the reflected wave from the weld portion 303 is detected is different from the period at which the reflected waves from other portions are detected. The processing device 230 filters the intensity distribution in the Z-direction by using a preset thickness of the weld portion 303. As a result, the processing device 230 extracts the reflected wave component from the weld portion 303. The processing device 230 calculates the centroid position of the intensity distribution in the X-Y plane after filtering as the center position of the weld portion 303.

Or, the processing device 230 may determine the weld portion 303 and calculate the center position based on the determined weld portion 303. As shown in FIGS. 12B and 12C, the period of the reflected wave from the weld portion 303 is different from the period of the reflected wave from the other portions. For points in the X-Y plane, the metal plate 301 and the metal plate 302 can be considered not to be joined at the points at which the peak Pe2 shown in FIG. 12B is detected. For example, the processing device 230 applies a filter for extracting the peak Pe2 to the detection result of the reflected waves. The points at which the peak Pe2 is not extracted are determined to be joined. The points at which the peak Pe2 is extracted are determined not to be joined. The cluster of the joined points corresponds to the weld portion 303.

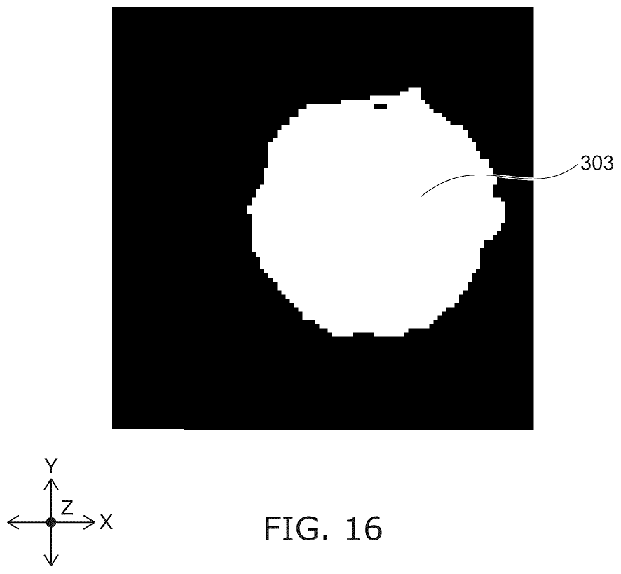

FIG. 16 is a schematic view illustrating the determined weld portion.

In FIG. 16, the points that are determined to be joined based on the intensity data are illustrated using white. The points that are determined not to be joined are illustrated using black. A cluster of points determined to be joined is determined to be the weld portion 303. The system control unit 220 calculates the centroid position in the X-Y plane of the determined weld portion 303 as the center position of the weld portion 303. Or, the system control unit 220 may calculate the center of a circle inscribing or circumscribing the determined weld portion 303 in the X-Y plane as the center position of the weld portion 303.

The center of the detector 122 is positioned at the center of the detection result of the reflected waves in the X-Y plane. Accordingly, the misalignment of the center position of the weld portion 303 with respect to the center position of the detection result of the reflected waves corresponds to the misalignment of the center position of the detector 122 with respect to the center position of the weld portion 303.

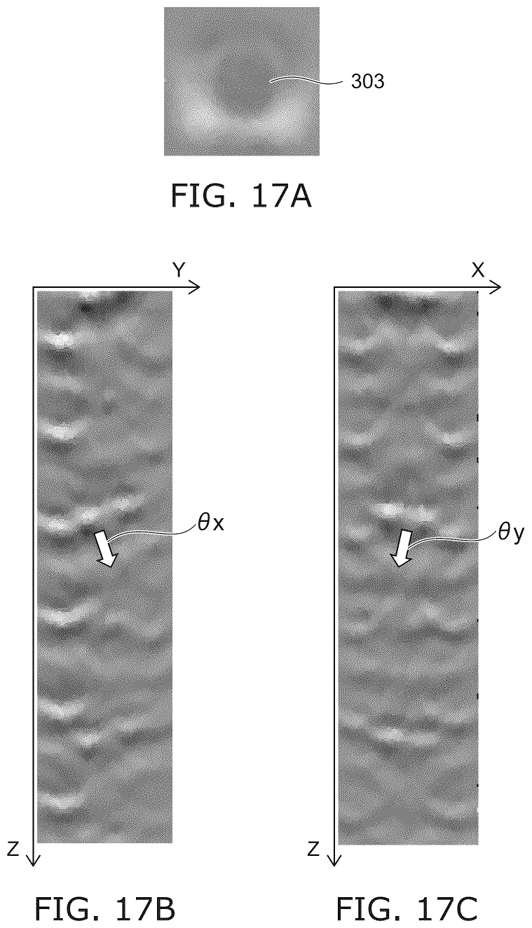

FIGS. 17A to 17C are other examples of images of the reflected wave intensity distribution obtained by processing the intensity data.

The calculation method of the tilt will now be described. FIG. 17A is an image of the reflected wave intensity distribution in the X-Y plane at the weld portion 303 vicinity. FIG. 17B is an image of the reflected wave intensity distribution in the Y-Z plane at the weld portion 303 vicinity. FIG. 17C is an image of the reflected wave intensity distribution in the X-Z plane at the weld portion 303 vicinity. In FIGS. 17A to 17C, the intensity is illustrated in grayscale. The luminance corresponds to the intensity of the reflected wave. In other words, a bright pixel color indicates that the reflected wave intensity at that point is high.

The system control unit 220 calculates a tilt Ox in the Y-Z plane of the weld portion 303 and a tilt Oy in the X-Z plane of the weld portion 303. As shown in FIG. 17B, the tilt θx is calculated based on the detection result in the Y-Z plane. As shown in FIG. 17C, the tilt θy is calculated based on the detection result in the X-Z plane. For example, the system control unit 220 calculates the average of the gradients around the X-direction as the tilt ex. The system control unit 220 calculates the average of the gradients around the Y-direction as the tilt θy. The tilt θx and the tilt θy correspond to the tilt of the detector 122 with respect to the weld portion 303.

By using the result of the probe to calculate the misalignment and the tilt, and by appropriately correcting the misalignment and the tilt, the detector 122 can be set to a posture more suited to the probe.

After the posture of the end effector mounted to the manipulator 110 is taught, the robot system 1 is used to inspect the joined body 300. When multiple weld portions 303 are formed in one joined body 300, teaching points are set respectively for the weld portions 303.

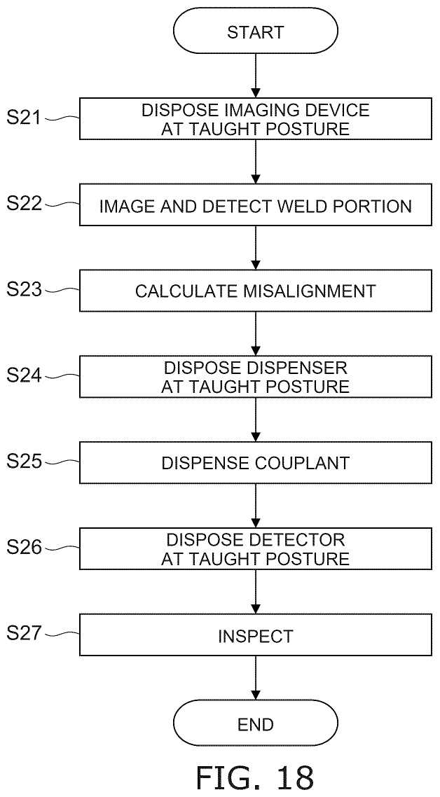

FIG. 18 is a flowchart showing an operation of the robot system according to the embodiment.

The robot controller 200 disposes the imaging device 121 at the taught posture by moving the manipulator 110 (step S21). The imaging device 121 images the joined body 300; and the processing device 230 detects the weld portion 303 based on the image (step S22). The system control unit 220 compares the position of the weld portion 303 detected based on the image with a preregistered position of the weld portion 303. The system control unit 220 calculates the misalignment of the detected position with respect to the registered position (step S23).

The robot controller 200 disposes the dispenser 123 at the taught posture by moving the manipulator 110 (step S24). At this time, the robot controller 200 adjusts the posture of the dispenser 123 to correct the misalignment calculated in step S23. The dispenser 123 dispenses the couplant toward the weld portion 303 (step S25).

The robot controller 200 disposes the detector 122 at the taught posture by moving the manipulator 110 (step S26). The detector 122 is disposed at the approach start position. At this time, the robot controller 200 adjusts the posture of the detector 122 to correct the misalignment calculated in step S23. The robot controller 200 inspects the weld portion 303 (step S27).

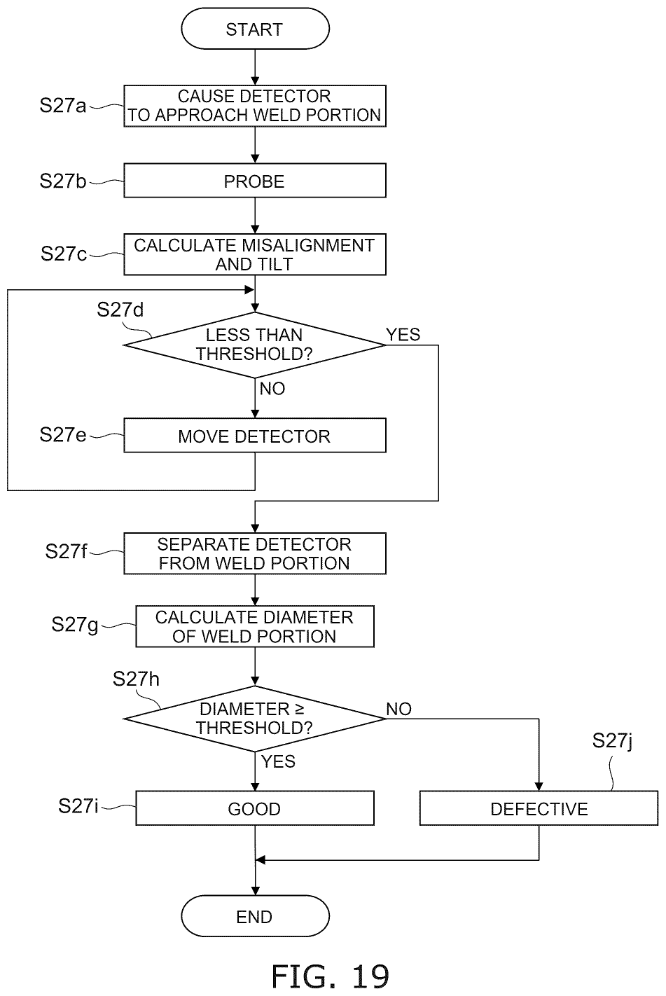

FIG. 19 is a flowchart showing the inspection by the robot system according to the embodiment.

In the inspection, similarly to the processing shown in FIG. 13, the approach of the detector 122 (step S27a), probing (step S27b), calculation of the misalignment and the tilt (step S27c), comparing with the threshold (step S27d), moving the detector 122 (step S27e and step S27f), etc., are performed. After step S27f, the processing device 230 uses the detection result of the reflected waves obtained in step S27b directly-previous to determine the weld portion 303 and calculate the diameter of the weld portion 303 (step S27g). The diameter is the length of the weld portion 303 in any one direction. The processing device 230 compares the diameter with a threshold (step S27h). When the diameter is not less than the threshold, the processing device 230 determines that the joint of the weld portion 303 is good (step S27i). When the diameter is less than the threshold, the processing device 230 determines that the joint of the weld portion 303 is defective (step S27j). Thus, the inspection of the weld portion 303 is completed.

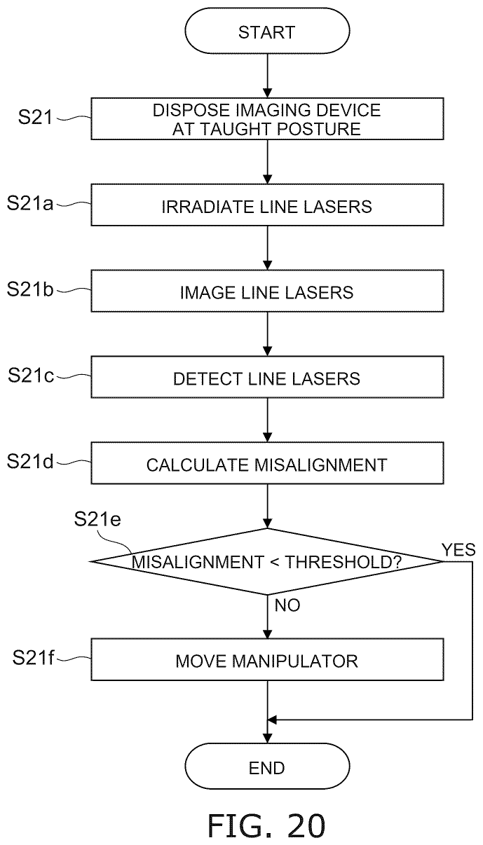

FIG. 20 is a flowchart showing an operation of the robot system according to the embodiment.

When setting the posture of the imaging device 121 in step S21, the posture of the imaging device 121 may be adjusted using the first light-emitting part 131 and the second light-emitting part 132. When using the robot 100, the object is transferred to a preset position with respect to the robot 100. When, however, the accuracy of the transfer position is insufficient, there are cases where the positional relationship between the robot 100 and the object is misaligned from the preset positional relationship. The misalignment may be corrected using the first light-emitting part 131 and the second light-emitting part 132.

After the imaging device 121 is disposed at the taught posture in step S21, the first light-emitting part 131 and the second light-emitting part 132 respectively irradiate the first line laser L1 and the second line laser L2 (step S21a). The imaging device 121 images the first line laser L1 and the second line laser L2 irradiated on the surface of the object (step S21b). The system control unit 220 detects the first line laser L1 and the second line laser L2 based on the image (step S21c).

The system control unit 220 calculates the misalignment between the first line laser L1 and the second line laser L2 (step S21d). For example, the system control unit 220 calculates the translation amount and the rotation amount necessary for one of the first line laser L1 or the second line laser L2 to overlap the other of the first line laser L1 or the second line laser L2 as the misalignment. The system control unit 220 determines whether or not the misalignment is less than a threshold (step S21e). When the misalignment is not less than the threshold, the robot controller 200 moves the manipulator 110 based on the calculated movement amount so that the first line laser L1 and the second line laser L2 overlap each other (step S21f). As a result, the imaging device 121 can be set to a more appropriate posture. When step S21f is performed, the posture of the imaging device 121 after step S21f may be registered as the taught posture.

An example is described above in which the imaging device 121, the detector 122, and the dispenser 123 are used as three end effectors. The end effectors are not limited to the example; only the imaging device 121 and the detector 122 may be included as end effectors. For example, the use of the couplant can be omitted by increasing the acoustic compatibility between the propagating part 122b and the weld portion 303 by including a soft member in the propagating part 122b. In such a case, the posture of the detector 122 may be adjusted based on a preregistered posture relationship of the imaging device 121 and the detector 122 after the posture of the imaging device 121 is taught using the first light-emitting part 131 and the second light-emitting part 132.

Instead of the imaging device 121, the detector 122, and the dispenser 123, the end effector may be a device patterning a workpiece, a device inspecting a workpiece, a device measuring a workpiece, etc. Regardless of the end effector that is used, each end effector has an appropriate posture. By using the first light-emitting part 131 and the second light-emitting part 132, it is easy to set the end effector to the appropriate posture.

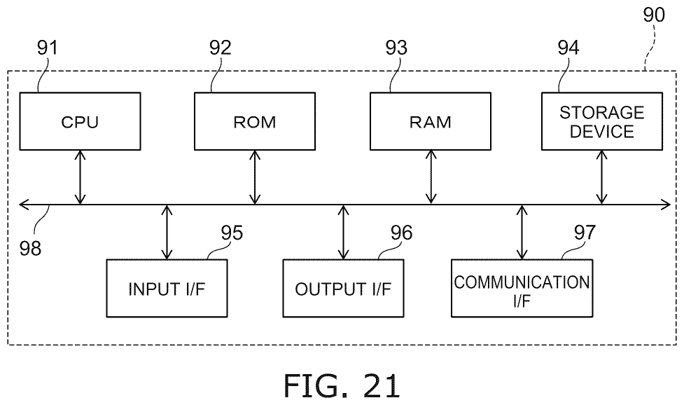

FIG. 21 is a schematic view illustrating a hardware configuration.

A computer 90 shown in FIG. 21 is used as each of the system control unit 220, the robot controller 200, the operation terminal 210, and the processing device 230. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes at least one selected from a hard disk drive (HDD) and a solid state drive (SSD).

The input interface (I/F) 95 can connect the computer 90 and an input device. The input I/F 95 is, for example, a serial bus interface such as USB, etc. The CPU 91 can read various data from the input device via the input I/F 95.

The output interface (I/F) 96 can connect the computer 90 and an output device. The output I/F 96 is, for example, an image output interface such as Digital Visual Interface (DVI), High-Definition Multimedia Interface (HDMI (registered trademark)), etc. The CPU 91 can transmit data to the output device via the output I/F 96 and cause the output device to display an image.

The communication interface (I/F) 97 can connect the computer 90 and a server outside the computer 90. The communication I/F 97 is, for example, a network card such as a LAN card, etc. The CPU 91 can read various data from the server via the communication I/F 97.

The processing performed by the robot controller 200, the operation terminal 210, the system control unit 220, and the processing device 230 may be realized by one computer 90 or may be realized by collaboration of multiple computers 90. For example, one computer may include two or more functions selected from the robot controller 200, the operation terminal 210, the system control unit 220, and the processing device 230. One function of the robot controller 200, the operation terminal 210, the system control unit 220, or the processing device 230 may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

Embodiments of the invention include the following features.

### Feature 1

A robot, including:
a manipulator;
a first end effector mounted to a distal part of the manipulator;
a first light-emitting part mounted to the distal part, the first light-emitting part irradiating a first line laser in a first direction; and
a second light-emitting part mounted to the distal part, the second light-emitting part irradiating a second line laser in a second direction,
the first direction being tilted with respect to an orientation of the first end effector in a first plane, the first plane being parallel to a direction from the distal part toward the first end effector,
the second direction being tilted with respect to the orientation of the first end effector in a second plane, the second plane being parallel to the first direction and crossing the first plane.

### Feature 2

The robot according to feature 1, in which
the first light-emitting part and the second light-emitting part are mounted so that the first line laser and the second line laser have a prescribed positional relationship when a positional relationship between the first end effector and an object is in a prescribed state.

### Feature 3

The robot according to feature 1 or 2, in which
the first end effector includes an imaging device, and
the first light-emitting part and the second light-emitting part are mounted so that
   a focal point of the imaging device is positioned at a surface of an object, and
   the first line laser and the second line laser overlap when the imaging device squarely faces the object.

### Feature 4

The robot according to any one of features 1 to 3, in which
the first light-emitting part and the second light-emitting part irradiate the first line laser and the second line laser when teaching a posture of the first end effector.

### Feature 5

The robot according to any one of features 1 to 4, further including:
a second end effector mounted to the distal part,
the manipulator being moved based on a positional relationship between the first end effector and the second end effector after teaching a posture of the first end effector.

### Feature 6

The robot according to feature 5, in which
the second end effector includes a detector configured to transmit an ultrasonic wave and detect a reflected wave.

### Feature 7

The robot according to any one of features 1 to 6, in which
a color of the second line laser is different from a color of the first line laser.

### Feature 8

A light-emitting device, including:
a first light-emitting part and a second light-emitting part mounted to a distal part of a manipulator,
the first light-emitting part irradiating a first line laser in a first direction,
the second light-emitting part irradiating a second line laser in a second direction,
the first direction being tilted with respect to an orientation of the first end effector in a first plane, the first plane being parallel to a direction from the distal part toward a first end effector mounted to the distal part,
the second direction being tilted with respect to the orientation of the first end effector in a second plane, the second plane being parallel to the direction and crossing the first plane,
the first light-emitting part and the second light-emitting part being mounted so that the first line laser and the second line laser overlap when a positional relationship between the first end effector and an object is in a prescribed state.

### Feature 9

A teaching method of a robot,
the robot including
   a manipulator,
   a first end effector mounted to a distal part of the manipulator,
   a first light-emitting part mounted to the distal part, the first light-emitting part irradiating a first line laser in a first direction, the first direction being tilted with respect to an orientation of the first end effector in a first plane, the first plane being parallel to a direction from the distal part toward the first end effector, and
   a second light-emitting part mounted to the distal part, the second light-emitting part irradiating a second line laser in a second direction, the second direction being tilted with respect to the orientation of the first end effector in a second plane, the second plane being parallel to the direction and perpendicular to the first plane,
the method including:
   irradiating the first line laser and the second line laser on a surface of an object; and
   teaching a posture of the first end effector to the robot when the first line laser and the second line laser have a prescribed positional relationship.

### Feature 10

The method according to feature 9, in which
the first light-emitting part and the second light-emitting part are mounted so that the first line laser and the second line laser have a prescribed positional relationship when a positional relationship between the first end effector and the object is in a prescribed state.

### Feature 11

The method according to feature 9 or 10, in which
the first end effector includes an imaging device, and
the first light-emitting part and the second light-emitting part are mounted so that
   a focal point of the imaging device is positioned at the surface of the object, and
   the first line laser and the second line laser overlap when the imaging device squarely faces the object.

### Feature 12

The method according to any one of features 9 to 11, in which
the first light-emitting part and the second light-emitting part irradiate the first line laser and the second line laser when teaching the posture of the first end effector.

### Feature 13

The method according to any one of features 9 to 12, further including:
a second end effector mounted to the distal part,
the manipulator being moved based on a positional relationship between the first end effector and the second end effector after teaching the posture of the first end effector.

### Feature 14

The method according to feature 13, in which
the second end effector includes a detector configured to transmit an ultrasonic wave and detect a reflected wave.

According to the embodiments above, a robot 100 and a teaching method are provided in which an end effector can be set more easily to a more appropriate posture. By mounting a light-emitting device that includes the first and second light-emitting parts 131 and 132 to the distal part of the manipulator 110, the end effector can be set more easily to a more appropriate posture.

In the specification, “or” means that “at least one” of the components listed in the text can be employed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A robot, comprising:
a manipulator;
a first end effector mounted to a distal part of the manipulator;
a first light-emitting part mounted to the distal part, the first light-emitting part irradiating a first line laser in a first direction; and
a second light-emitting part mounted to the distal part, the second light-emitting part irradiating a second line laser in a second direction,
the first direction being tilted with respect to an orientation of the first end effector in a first plane, the first plane being parallel to a direction from the distal part toward the first end effector,
the second direction being tilted with respect to the orientation of the first end effector in a second plane, the second plane being parallel to the first direction and crossing the first plane.

2. The robot according to claim 1, wherein
the first light-emitting part and the second light-emitting part are mounted so that the first line laser and the second line laser have a prescribed positional relationship when a positional relationship between the first end effector and an object is in a prescribed state.

3. The robot according to claim 1, wherein
the first end effector includes an imaging device, and
the first light-emitting part and the second light-emitting part are mounted so that
a focal point of the imaging device is positioned at a surface of an object, and
the first line laser and the second line laser overlap when the imaging device squarely faces the object.

4. The robot according to claim 1, wherein
the first light-emitting part and the second light-emitting part irradiate the first line laser and the second line laser when teaching a posture of the first end effector.

5. The robot according to claim 1, further comprising:
a second end effector mounted to the distal part,
the manipulator being moved based on a positional relationship between the first end effector and the second end effector after teaching a posture of the first end effector.

6. The robot according to claim 5, wherein
the second end effector includes a detector configured to transmit an ultrasonic wave and detect a reflected wave.

7. The robot according to claim 1, wherein
a color of the second line laser is different from a color of the first line laser.

8. A light-emitting device, comprising:
a first light-emitting part and a second light-emitting part mounted to a distal part of a manipulator,
the first light-emitting part irradiating a first line laser in a first direction,
the second light-emitting part irradiating a second line laser in a second direction,
the first direction being tilted with respect to an orientation of a first end effector in a first plane, the first plane being parallel to a direction from the distal part toward the first end effector mounted to the distal part,
the second direction being tilted with respect to the orientation of the first end effector in a second plane, the second plane being parallel to the direction and crossing the first plane,
the first light-emitting part and the second light-emitting part being mounted so that the first line laser and the second line laser overlap when a positional relationship between the first end effector and an object is in a prescribed state.

9. A teaching method of a robot,
the robot including
a manipulator,
a first end effector mounted to a distal part of the manipulator,
a first light-emitting part mounted to the distal part, the first light-emitting part irradiating a first line laser in a first direction, the first direction being tilted with respect to an orientation of the first end effector in a first plane, the first plane being parallel to a direction from the distal part toward the first end effector, and
a second light-emitting part mounted to the distal part, the second light-emitting part irradiating a second line laser in a second direction, the second direction being tilted with respect to the orientation of the first end effector in a second plane, the second plane being parallel to the direction and perpendicular to the first plane,
the method comprising:
irradiating the first line laser and the second line laser on a surface of an object; and
teaching a posture of the first end effector to the robot when the first line laser and the second line laser have a prescribed positional relationship.

10. The method according to claim 9, wherein
the first light-emitting part and the second light-emitting part are mounted so that the first line laser and the second line laser have a prescribed positional relationship when a positional relationship between the first end effector and the object is in a prescribed state.

11. The method according to claim 9, wherein
the first end effector includes an imaging device, and
the first light-emitting part and the second light-emitting part are mounted so that
a focal point of the imaging device is positioned at the surface of the object, and
the first line laser and the second line laser overlap when the imaging device squarely faces the object.

12. The method according to claim 9, wherein
the first light-emitting part and the second light-emitting part irradiate the first line laser and the second line laser when teaching the posture of the first end effector.

13. The method according to claim 9, further comprising:
a second end effector mounted to the distal part,
the manipulator being moved based on a positional relationship between the first end effector and the second end effector after teaching the posture of the first end effector.

14. The method according to claim 13, wherein
the second end effector includes a detector configured to transmit an ultrasonic wave and detect a reflected wave.
